(19) United States
(12) Patent Application Publication
(10) Pub. No.: US 2012/0226410 A1
(43) Pub. Date: Sep. 6, 2012

(54) SYSTEM AND METHOD FOR MINIMIZING THE POWER DRAIN ON A BATTERY OF A VEHICLE

(75) Inventor: James Snider, Kildeer, IL (US)

(73) Assignee: CONTINENTAL AUTOMOTIVE SYSTEMS, INC., Deer Park, IL (US)

(21) Appl. No.: 13/041,130

(22) Filed: Mar. 4, 2011

(51) Int. Cl. G06F 7/00

(52) U.S. Cl. 701/36

(57) ABSTRACT

A system and method for minimizing the power drain on a battery of a vehicle includes a processor, a global positioning system in communication with the processor, and a network access device in communication with the processor. The global position system is configured to determine the position of the vehicle. The processor is configured to reduce the power demands of the network access device on a battery of the vehicle when the vehicle is located in a predetermined location and turned off.

### BACKGROUND

1. Field of the Invention

This invention relates to systems and methods for minimizing the power drain on a battery of a vehicle.

2. Description of Related Art

Electrical systems found in vehicles today include numerous safety, entertainment, and theft deterrent systems. While some entertainment and safety systems are usually powered off when the vehicle is parked and turned off, other systems, such as theft deterrent systems, keyless entry systems, and vehicle communication systems are operating.

While the operation of these systems have numerous advantages, one disadvantage is that these systems are constantly drawing power from the battery of the vehicle. This generally is not a problem, as long as the battery of the vehicle is routinely charged. However, in instances when the vehicle is parked for a prolonged period of time, there is a possibility that these electrical systems will drain the battery to such a degree that the vehicle will not be able to start the engine when directed by the driver of the vehicle.

One way to prevent the draining of the battery is to simply power off the electrical devices when the vehicle engine is not charging the battery of the vehicle. While this prevents draining of the battery, it also disables electronic systems that the driver of the vehicle expects to be operating, such as the keyless entry system, theft deterrent system, and other electronic communication systems. While this may be acceptable in certain situations, it is generally unacceptable in many situations when the driver of the vehicle is simply parking their vehicle for a short period of time and desires for these electronic systems to not be turned off to prevent draining of the battery.

### SUMMARY

A system and method for minimizing the power drain on a battery of a vehicle includes a processor, a global positioning system in communication with the processor, and a network access device in communication with the processor. The global position system is configured to determine the position of the vehicle. The processor is configured to reduce the power demands of the network access device on a battery of the vehicle when the vehicle is located in a predetermined location and turned off.

Further objects, features and advantages of this invention will become readily apparent to persons skilled in the art after a review of the following description, with reference to the drawings and claims that are appended to and form a part of this specification.

### BRIEF DESCRIPTION OF THE DRAWINGS

FIG. 1 illustrates an vehicle incorporating the system and method for minimizing power drain on a battery of the vehicle;

FIG. 2 illustrates in greater detail the system for minimizing the power drain on the battery of the vehicle of FIG. 1; and

FIG. 3 illustrates the method for minimizing the power drain on the battery of the vehicle illustrated in FIG. 1.

### DETAILED DESCRIPTION

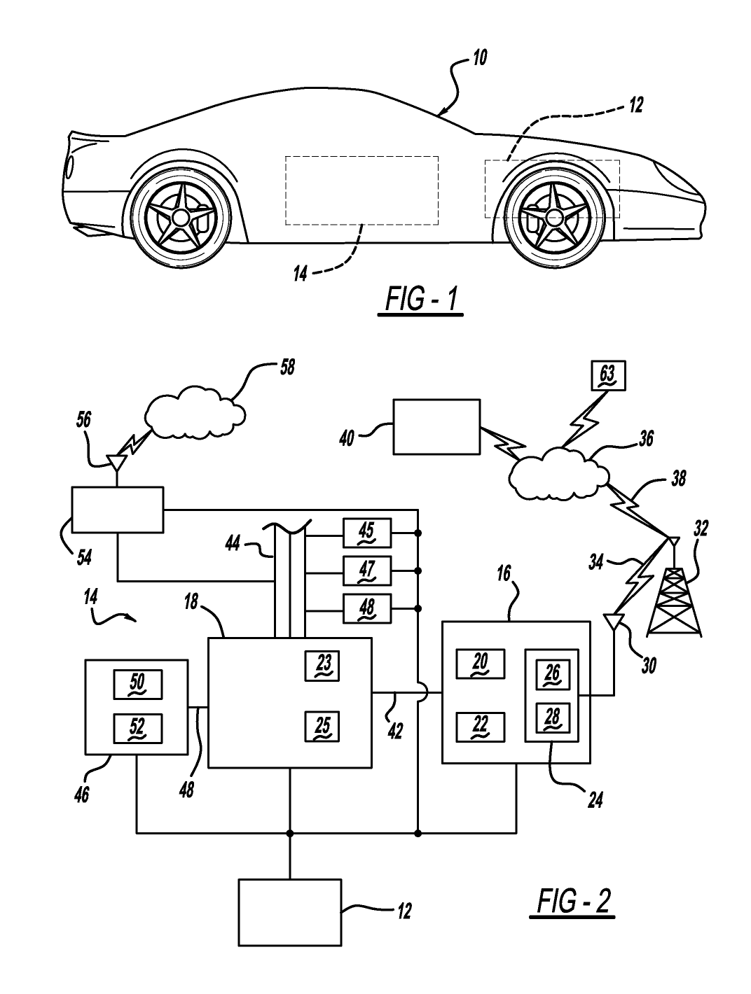

Referring to FIG. 1, a vehicle 10 is shown. The vehicle 10 can be any type of vehicle, such as a car, truck, sport utility vehicle, recreational vehicle, or tractor trailer. Additionally, the vehicle 10 can include other types of vehicles for transporting an occupant from one place to another. This would include vehicles like boats, motorcycles and construction equipment.

Located within the vehicle 10 is a battery system 12. Generally, the battery system is a single unit containing multiple cells, however, it should be understood that the battery system may contain multiple batteries placed at separate locations within the vehicle 10. Also located within the vehicle 10 is a system 14 for minimizing the power drain on the battery 12 of the vehicle 10. Generally, the battery 12 of the vehicle is charged when an engine of the vehicle 10 is running. However, when the engine of the vehicle 10 is not running, the battery 12 will provide power to the system 14. As will be described in the paragraphs that follow, the system 14 not only includes the system for minimizing the power drain on the battery 12 but also includes other electronic components that are powered by the battery 12 of the vehicle 10.

Referring to FIG. 2, the system 14 for minimizing the power drain on the battery 12 of the vehicle is shown. The system 14 includes a network access device 16 and a telematics controller 18. The network access device 16 may include a processor 20 and storage 22. The processor 20 may be a programmable microprocessor or alternatively may be an application specific integrated circuit (ASIC), or other known processor. The storage 16 may be a memory, for example, random access memory, static memory, or other data storage device. The network access device 16 may also include a transceiver 24 which includes a transmitter 26 and a receiver 28. Alternatively, the network access device 16 may include an independent transmitter and receiver. The transceiver 24 may be in communication with an antenna 30. The transceiver 24 may communicate with the radio tower 32 as denoted by line 34. The communication 34 between the network access device 16 and the radio tower 32 may comprise one of a plurality of communication modes.

The transceiver 24 and the network access device 16 may be used for transmitting uplink communications and receiving downlink communications to and from a network 36 over a wireless communication link 38. The wireless communication link 38 may use a wireless protocol such as the standard cellular network protocol such as Advanced Mobile Phone Service (AMPS), Global System for Mobile Communications (GSM), the Time Division Multiple Access (TDMA), Code Division Multiple Access (CDMA), and the like. To transmit data in the cellular environment, different types of standard bare services exist including, but limited to, General Packet Radio Service (GPRS), Short Message Service (SMS), Circuit Switched Data Service (CSD), High Speed Circuit Switched Data Service (HSCSD). Further, Standard Transmission Control Protocol/Internet Protocol (TCP/IP) may also be used as well as satellite communications. In a further example, the transceiver 24 may be enabled using other wireless technologies such as BlueTooth® technology. BlueTooth® technology allows for the replacement of a wire connection by enabling the device to communication with each other through a universal short range radio length.

The radio tower 32 may be in communication with a service provider 40 including for example, a network server through a network 36. The network 36 may be an analog network, such as a plain old telephone service (POTS), or a digital network for example, Ether Net over transmission control protocol/internet protocol (TCP/IP). In other examples, the network 36 could be one of several standard cellular communication networks, a satellite based network, a Public Switch Telecommunication Network (PSTN), the internet, an Integrated Services Digital Network (ISDN), and/or other communication networks. The service provider 40 may operate the service center to provide telematics applications and services to the vehicle. For instance, the service provider 40 may contain operators, content service, and content data bases. The content service for telematics applications and services may include traffic servers, map servers, user profile servers, location information servers, and the like. The content data bases for the telematics applications and services may include location information, user profiles, traffic content, map content, point of interest content, usage history, and the like.

The network access device 16 may be in communication with the telematics controller 18 through a communication interface 42. In some implementations, the network access device 16 may be in the same package as the telematics controller 18. However, other implementations of the network access device 16 may be provided in a separate package from the package of the telematics controller 18 and therefore may be located in a different area of the vehicle. Various information may be communicated between the telematics controller 18 and the network access device 16.

The telematics controller 18 may include a processor 23 and storage 25. The processor 23 may be a microprocessor or may be an application specific integrated circuit. Further, the storage 25 may be a memory device for example, random access memory, read only memory, static memory, or even a hard drive or optical drive, or other means of data storage. The telematics controller 18 may be in communication with a plurality of other vehicle sensors and devices through a wire harness or over the vehicle bus as denoted by line 44. These devices can include, but are not limited to keyless entry devices 46 and vehicle security devices 48. Additionally, the telematics controller 18 may be in communication with a vehicle ignition system 46, which can control and/or indicate if the ignition of the vehicle is engaged, allowing the telematics controller 18 to determine if the vehicle is on.

In addition, the telematics controller 18 may be in communication with a user interface 46 as denoted by line 48. The user interface 46 may include a display 50 and controls 52 for providing user input such as vehicle parameters into the telematics controller 18. Also, the user interface 46 may include elements such as a keyboard or keypad, one or more control buttons, indicator lights, one or more speakers, a microphone, and any other user interface type elements for telematics applications and services.

The telematics controller 18 may also be connected to a positioning unit 54. The positioning unit 54 could be a system that determines the geographic location of the vehicle, such as a global positioning system, a dead reckoning system, and the like. In this embodiment, the positioning system 54 has an antenna 56 which communicates to a global positioning satellite system 58. By so doing, the positioning system 54 can determine a location of the vehicle by utilizing the global positioning satellite system 58 via the antenna 56.

Further, the telematics controller 18 may be in communication with other vehicle systems, such as the engine control system, the vehicle locks, the vehicle safety systems, the vehicle entertainment systems, or suspension control systems to control the described functions of the telematics controller 16 or network access device 18 based on parameters of such systems.

As stated before, the vehicle has a battery 12. The battery 12 provides power to the network access device 16, the telematics controller 18, the user interface 46, the positioning system 54, and other systems such as the keyless entry system 47, and vehicle security device 48.

When the vehicle is running, the battery 12 will be charged. However, when the vehicle is turned off, so that the vehicle ignition system 45 is no longer switched on, several of the electronic devices of the vehicle are still drawing power from the battery. This can include the keyless entry system 47 and the vehicle security device 48. Additionally, other systems may also be draining power from the battery 12, such as the network access device 16 which may be sending and receiving information to the telematic service provider 40. As noted previously, this can create a drain on the battery 12 of the vehicle and can possibly deplete the battery such that the vehicle 10 will not be able to start if the battery 12 of the vehicle 10 is not charged. This can occur when the vehicle of the battery is parked for lengthy periods of time.

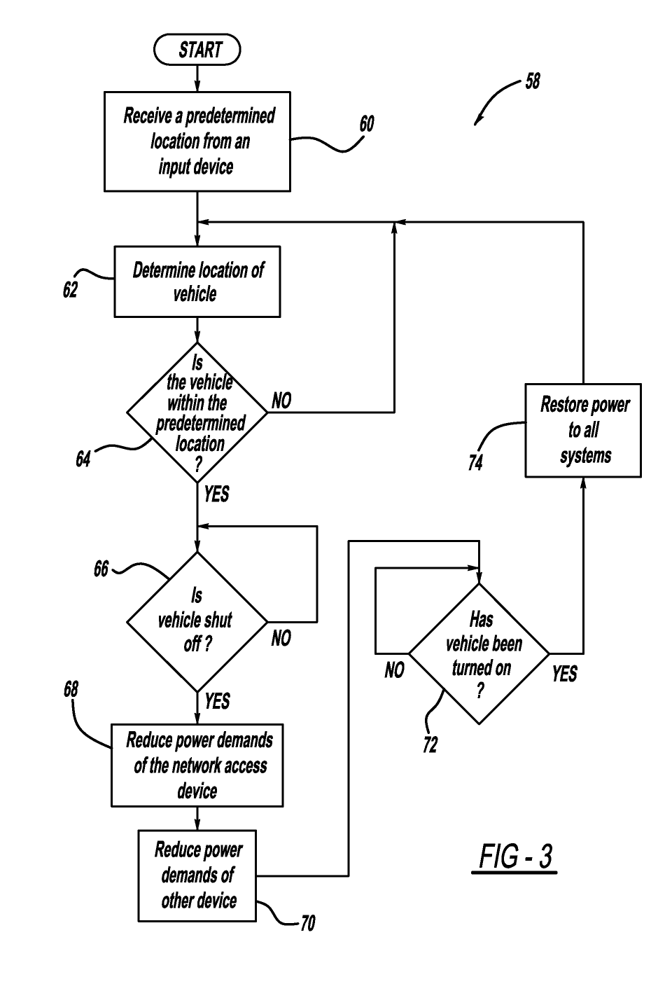

Referring to FIG. 3, a method 58 for minimizing the power drain on the battery 12 of the vehicle 10 is described. Reference will be made to both FIGS. 1 and 2 when describing the method 58. The method 58 may be embodied in a computer readable storage medium having stored therein instructions executable by a programmed processor.

In step 60, the telematics controller 18 receives a predetermined location from an input device. This predetermined location is generally stored in the storage 25. Further, the predetermined location may comprise more than one location. This input device could be the user interface 46 or could be a remote input device 63 that is communicating with the telematics controller 18 via the network access device 16 through the network 36. The remote input device 63 could be a general purpose computer or could be any other electronic device capable of accessing the network 36, such as a smart phone.

Once the telematics controller 18 receives and stores the predetermined location from the input device, a determination may be made regarding the location of the vehicle 10 in step 62. Here, the positioning system 54 can utilize the global positioning satellites 58 to determine a location of the vehicle and inform the telematics controller 18 of the location of the vehicle.

In step 64, the telematics controller 18 may determine if the vehicle is within a predetermined location. Essentially, the telematics controller 18 uses the positioning information from the positioning system 54 and makes a comparison to determine if the vehicle 10 is within the predetermined location. In step 66, the telematics controller 18 determines if the vehicle 10 is shut off. This determination can be made by having the telematics controller 18 monitor the vehicle ignition system 45 and determine if the vehicle 10 is on. If the vehicle is not shut off, the method returns to step 66. If the vehicle is shut off, the telematics controller 18 reduces the power demand of the network access device 16, as illustrated in step 68.

Reducing the power of the network access device 16 can be accomplished by simply turning off the network access device 16 or limiting the network access device's 16 communication with the network 36 to a few defined time intervals. By so doing, the network access device 16 will not drain the battery as much as it would under normal operation. Additionally, the telematics controller 18 could also shut down the keyless entry system 47 and the security device 48 of the vehicle 10 to further reduce the power demands on the battery 12 of the vehicle as illustrated in step 70.

In step 72, a determination is made if the vehicle 10 has been turned on by monitoring the vehicle ignition system 45. If the vehicle 10 has not been turned on, the method returns to step 72. However, if the vehicle 10 is turned on, the method continues to step 74 where all power is restored to all systems. Thereafter, the method returns to step 62.

While the above description constitutes the preferred embodiment of the present invention, it will be appreciated that the invention is susceptible to modification, variation, and change without departing from the proper scope and fair meaning of the accompanying claims.

In other embodiments, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

Further, the methods described herein may be embodied in a computer-readable medium. The term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

As a person skilled in the art will readily appreciate, the above description is meant as an illustration of the principles of the invention. This description is not intended to limit the scope or application of the invention in that the invention is susceptible to modification, variation and change, without departing from spirit of the invention, as defined in the following claims.

I/we claim:

1. A system for minimizing power drain on a battery of an vehicle, the system comprising:
a processor;
a global positioning system in communication with the processor, wherein the global position system is configured to determine the position of the vehicle;
a network access device in communication with the processor, the network access device receiving power from the battery of the vehicle, the network access device having a controller in communication with an antenna for sending or receiving data from a wireless network;
wherein the processor is configured to reduce power consumption of the network access device on the battery of the vehicle when the vehicle is located in a predetermined location and turned off.

2. The system of claim 1, wherein the processor is configured to power off the network access device when the vehicle is located in a predetermined location and turned off.

3. The system of claim 1 further comprising:
a remote keyless entry system in communication with the processor;
the remote keyless entry system in communication with a remote keyless entry antenna for receiving data from a remote device; and
the remote keyless entry system receiving power from the battery of the vehicle.

4. The system of claim 3, wherein the processor is configured to reduce power consumption of the remote keyless entry system on the battery of the vehicle when the vehicle is located in a predetermined location and turned off.

5. The system of claim 1 further comprising a vehicle theft deterrent system in communication with the processor, the vehicle theft deterrent system receiving power from the battery of the vehicle.

6. The system of claim 5, wherein the processor is configured to reduce power consumption of the vehicle theft deterrent system on the battery of the vehicle when the vehicle is located in a predetermined location and turned off.

7. The system of claim 1 further comprising an input system in communication with the processor, whereby the input system receives the predetermined location from a user.

8. The system of claim 7, wherein the input system is in communication with the processor through the network access device.

9. The system of claim 7, wherein the input system is located within an occupant compartment of the vehicle.

10. A method for minimizing the power drain on a battery of an vehicle, the method comprising the steps of:
receiving a predetermined location from an input system;
determining the a location of the vehicle; and
reducing power consumption of the network access device on the battery of the vehicle when the vehicle is located in the predetermined location

11. The method of claim 10, further comprising the step of powering off the network access device when the vehicle is located in a predetermined location and turned off.

12. The method of claim 10, further comprising the step of reducing power consumption of a remote keyless entry system on the battery of the vehicle when the vehicle is located in a predetermined location and turned off.

13. The method of claim 10, further comprising the step of reducing power consumption of the vehicle theft deterrent system on the battery of the vehicle when the vehicle is located in a predetermined location and turned off.

14. The method of claim 10, wherein the input system is a wireless device.

15. The method of claim 10, wherein the input system is located within an occupant compartment of the vehicle.

16. In a computer readable storage medium having stored therein instructions executable by a programmed processor for minimizing the power drain on a battery of an vehicle, the storage medium comprising instructions for:
receiving a predetermined location from an input system;
determining the a location of the vehicle; and
reducing power consumption of the network access device on the battery of the vehicle when the vehicle is located in the predetermined location

17. The computer readable storage medium of claim 16, further comprising the step of powering off the network access device when the vehicle is located in a predetermined location and turned off.

18. The computer readable storage medium of claim 16, further comprising the step of reducing power consumption of a remote keyless entry system on the battery of the vehicle when the vehicle is located in a predetermined location and turned off.

19. The computer readable storage medium of claim 16, further comprising the step of reducing power consumption of the vehicle theft deterrent system on the battery of the vehicle when the vehicle is located in a predetermined location and turned off.

20. The computer readable storage medium of claim 16, wherein the input system is a wireless device.

21. The computer readable storage medium of claim 16, wherein the input system is located within an occupant compartment of the vehicle.
